(19) United States
(12) Patent Application Publication
(10) Pub. No.: US 2014/0164049 A1
(43) Pub. Date: Jun. 12, 2014

(54) PROVIDING WORKFLOW PROCESSES TO CROWDSOURCED PRODUCT LISTINGS

(71) Applicant: PRODUCT FUNDER, INC., Bozeman, MT (US)

(72) Inventors: David J. Yakos, Bozeman, MT (US); Stephen M. Sanford, Bozeman, MT (US); Joby Rodell Rudolph, Bozeman, MT (US); Ryan Peter Murphy, Bozeman, MT (US)

(73) Assignee: PRODUCT FUNDER, INC., Bozeman, MT (US)

(21) Appl. No.: 13/711,446

(22) Filed: Dec. 11, 2012

(51) Int. Cl. G06Q 10/06

(52) U.S. Cl. CPC G06Q 10/0633
USPC 705/7.27

(57) ABSTRACT

Systems and methods to provide a set of qualifying steps for a crowdsourced project during creation of the project, where the steps are coupled with cost calculators, medal awards, partner identification, and third party auditing. The systems and methods allow an efficient project entry method while also scoring the completeness of the project to potential funding users. The inclusion of stretch goals, added at any time during the creation or funding of a project allows dynamic adjustment of target funding levels and awards, providing incentives for increased funding. Described herein is a system and method to create crowdfunded projects along with quality control checks visible to funders and incentives to induce more funders and greater funding levels, at the same time as creating a higher project success rate.

### FIELD

This disclosure relates generally to systems and methods for crowdsourced product creation, more particularly, to provide a workflow process and elements to aid in the creation of a crowdsourced product listing.

### BACKGROUND

The economy is shifting from a top-down manufacturing centered process to a consumer driven process. More products are succeeding due to their obsessive focus not just on the consumer's basic functional needs, but also on the emotional experience and desire to interact with the product. Consider the comparison between the Apple iPhone and the Chrysler K Car from the 1980s. Both met a basic functional need in the population, one a mobile phone, the other an automobile. Each worked well satisfying the basic requirements for their respective product areas, but one was designed with the user experience in mind while the other was designed based on what would be easy to produce.

With the emergence of social networks, the power and focus for product manufacturing has begun to shift even more so to a consumer focus. Social networks provide a common platform for discussion of products in a very democratized fashion where each consumer now has more of a voice about their experiences with the products. These social network interactions provide a sort of feedback forum on products that can influence future purchases of the products. Now the traditional approach of top-down design with limited focus groups and an emphasis on the production needs has been replaced by real, actual usage feedback in a manner that was never before conceived or possible.

At the same time, social networks have allowed consumer groups to form to create purchasing blocs that previously were only available to large corporations. In a large purchasing bloc, not only can these consumers negotiate a lower “bulk” price for items, they can also sometimes negotiate feature sets available in the products. For example, purchasing blocs of individuals formed via social networks could negotiate a bulk price for 50 computer laptops with a major computer manufacturer where each laptop is $150 less than available elsewhere. In this negotiation, they may also have the opportunity to specify a set of features that are not otherwise available in a particular model of laptop, such as a fingerprint reader or facial recognition system. Companies such as the major computer manufacturer are willing to work with this bloc of consumers in the same way that they would work with any other large purchasing entity because it allows them to have certainty around inventory and sales that would otherwise need to be absorbed in the market at a higher risk to the company.

As would be expected, the reverse focus is also commonly used. Amazon, for example, has become well known for its platform named “mechanical turks” where companies may post small work tasks and workers select a task to work and are paid upon completion. Numerous other similar platforms exist of varying size which allow for individual workers to find and get paid for their contributions. In this case, while the tasks are for the benefit of the company, they are similar to the above scenarios of product creation because one could easily envision the task as the product and the consumer feedback as the time to respond and the competition to select and work a task.

The combination of consumer focus, social networks, and purchasing blocs recently created a new form of product creation called “crowdsourcing”. Recently a new definition for crowdsourcing has emerged (Estellés Arolas, E.; González Ladrón-de-Guevara, F. 2012 Towards an integrated crowdsourcing definition. Journal of Information Science (in press)):
“Crowdsourcing is a type of participative online activity in which an individual, an institution, a non-profit organization, or company proposes to a group of individuals of varying knowledge, heterogeneity, and number, via a flexible open call, the voluntary undertaking of a task. The undertaking of the task, of variable complexity and modularity, and in which the crowd should participate bringing their work, money, knowledge and/or experience, always entails mutual benefit. The user will receive the satisfaction of a given type of need, be it economic, social recognition, self-esteem, or the development of individual skills, while the crowdsourcer will obtain and utilize to their advantage that what the user has brought to the venture, whose form will depend on the type of activity undertaken”.

In the present application, crowdsourcing and crowdfunding are used interchangeably, relating to the above definition. Notably, however, this emergence of crowdsourcing has also led to recent specific use of the term crowdfunding, to indicate where companies seeking financing are able to ask for financing via social networks. Because this area of crowdfunding is nearly as new as crowdsourcing, no rules or standard behaviors are yet known, and in the domain of financing there are numerous laws that are not structured to handle such a distributed financing approach. Thus, the US Congress is in the process of determining how to handle funding changes that may emerge from these new models. As such, the disclosure may interchangeably use crowdsourcing and crowdfunding without any specific narrowing of the definition of either term.

Just as these new funding approaches have some potentially serious concerns, crowdsourcing the creation of products also have potential and known problems. For example, the most well-known crowdfunding site is called “Kickstarter”. By their admission in supporting material, available at the URL “www.kickstarter.com/help/guidelines”, it exists primarily to focus on creative projects, “everything from traditional forms of art (like theater and music) to contemporary forms (like design and games).” Those wanting to source more traditional products are not allowed to create a Kickstarter project.

While Kickstarter's project choice is largely a business focus decision, that decision is backed by several aspects of their environment. Specifically, a focus on creative projects allows for a very simple product creation process that involves only a small number of steps. It is up to the project creator to understand the intricacies of product development and estimate times and costs accordingly. Unfortunately, many people who have never created a product are enticed by the simplicity of the crowdsourcing approach and the accessibility of a first market for the product. Thus, it has become a problem within the Kickstarter environment where over 41% of projects that have received funding have missed the deadlines set by the project creator.

Numerous other systems similar to Kickstarter exist in the art. For example U.S. Pat. No. 7,885,887 discusses the “Methods and apparatuses for financing and marketing a creative work.” Other example systems include ArtistShare, Pledgemusic, PleaseFund.Us, Funding4Learning, Gorackup, Indiegogo, GoFundMe, RocketHub, Fondomat, Rock The Post, Peerbackers and Sponsume, among many others. While each of these companies has seen various levels of success with their technical applications, each system is lacking in key components.

Thus, it is clear that people new to product development have an interest and a willing audience to attempt new, often niche, product development. However, prior art systems providing inexperienced product creators an easy access platform fail to provide them a structure within which to properly estimate the steps, timing, and costs of a project, and similarly previous systems fail to allow project funders to estimate the level of risk associated with each project in a crowdsourced system. No system in the art is capable to guide novices through the necessary steps to properly estimate and provide resources and information for crowdsourced campaigns.

### BRIEF DESCRIPTION OF THE DRAWINGS

For a better understanding of the embodiments of the inventive subject matter, reference may be made to the accompanying drawings in which:

FIG. 1 is a block diagram of a system according to embodiments;

FIG. 2 is a flowchart of one particular method for performing actions in accordance with funding interactions according to embodiments;

FIG. 3 is a flowchart of one particular method for performing actions in accordance with project creation and funding according to embodiments;

FIG. 4 is a flowchart of one particular method for project creation and example analyses performed during project creation according to embodiments;

FIG. 5 is a flowchart illustrating a method for project creators to interact during the funding period according to embodiments;

FIG. 6 is a flowchart illustrating a method for multiple paths to creating stretch goals according to embodiments;

FIG. 7 is a block diagram of an example embodiment of a computer system upon which embodiment's inventive subject matter can execute.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the example embodiments should correspond to the Figure number in which the item or part is first identified.

The description of the various embodiments is to be construed as exemplary only and does not describe every possible instance of the inventive subject matter. Numerous alternatives can be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to a crowdsourcing physical product development. The most common example discussed in detail is for the creation of a physical product such as a pet toy. This is only one example of a suitable environment and is not intended to suggest any limitation as to the scope of use or functionality of the inventive subject matter. Neither should it be interpreted as having any dependency or requirement relating to any one or a combination of components illustrated in the example operating environments described herein.

In general, various embodiments combine, in a crowdsourced project creation environment, workflow steps distinct for each product type and optionally with estimation calculations at each step, as well as optional recommendations for partner or alternative paths to completing each workflow step. Thus some embodiments aid those new to product development in a particular domain, quantifying the accuracy of their requests for money or estimates of time to completion, rating the quality of the request, and suggesting a risk associated with each project as well as providing help to the project creator where most needed.

In the specifics of discussing product development and its usage in a workflow environment, several definitions will be used in the specification. First, “product development” is any process relating to the process around any new human produced work that is designed and made, whether a physical product, an artistic creation, software, or other product that could be sold or used by others. The product development process includes multiple distinct “workflow” and “estimation” steps for planning the production of a product. These workflow and estimation steps may differ between different product classes, but vary within a standard range of knowable processes. Usually these steps must occur in a fixed order, but in some instances the order may be swapped or run in parallel. For example, the creation of a physical device includes the planning and estimation steps of creating a CAD drawing, manufacturing a prototype, developing tooling, mass production, packaging, etc. Obviously the packaging can be created in parallel with the tooling and mass production rather than occurring afterward. By extension for other product classes, the creation of software includes a design document instead of a CAD drawing, creating a demo user interface instead of a prototype device, developing frameworks and infrastructures instead of hardware tooling, etc., and frameworks can be constructed in parallel or before the demo user interface. Similarly, artistic endeavors such as composing a music album, filming a movie, or writing a novel have similar incremental tasks toward completing a finished product that are related to, but functionally distinct from each other as well as those in physical products and software.

In addition to a specific set of steps in the design process, each step provides the occasion to estimate monetary cost and temporal effort to help quantify the remaining time and money to complete each step in the process. For example, CAD drawings take a certain amount of effort and associated cost that is less than the mass production of the finished product. Similarly, knowing the lot size of a production run can impact costs, both per-item and total per lot, depending on whether it is a small lot of 10 or a large lot of 100,000.

Each step in the herein described workflow system includes the description of the step (e.g. creation of a CAD drawing) as well as one or more questions used to identify the level of knowledge and completeness of the step. For example, questions around this step could include, “1. Do you have a drawing of the product? (yes/no)”, “2. Is the drawing a sketch or a schematic drafting? (sketch/schematic)”, “3. Is the drawing electronically available to be used on a computer numerical control (CNC) machine tool? (yes/no)”. In some cases, a response can trigger a conditional following question depending upon the specific answer. For example, if the person responds that the drawing is only a sketch, the next question may be “2a. Do you have the ability to create the schematic yourself? (yes/no)”, wherein a negative response may elicit a following, “2b. Have you contacted a draftsman and received a quote? (yes/no)”, and another negative response may then lead to the display of draftsman partners available within the crowdsourcing site.

Similarly, each question, above, informs an estimation element within the system. For example, if industry averages for professional CAD renderings range from, say, $35 for simple objects with few parts to $350 for more complex objects with multiple parts, the system can use these costs to help the product creator quantify their specific monetary request. Given the questions and answers up to this point, the system may already know which end of the range to use as an estimate, or the product creator may simply enter a value. Optionally, with each subsequent question in the estimation module of product development steps, further refinement of an estimated cost range can be generated along with an estimate of the investment made to date before beginning the crowdsourced project. In addition, through repeated project use, estimates can be collected and refined over time making each interaction more accurate for subsequent system users.

The project creation process of some embodiments may include one or more preliminary steps. First there may be a basic product/project description which may include elements such as: Title, Description, Upload Assets (Images, Video). Further, there may be a set of project readiness questions. For a manufactured product those questions may include elements such as: Design In Place?, Prototype In Hand?, Manufacturer In Place?, Manufacturing Quotes?, Distribution Plan?, Financial Plan?, Marketing Plan?. For a software product those questions may include elements such as: Design In Place?, Prototype Code?, Distribution Plan?, Financial Plan?, Marketing Plan?. As seen here, each type of product has a distinct set of steps for successful completion. Next is a cost calculation element for setting a funding amount. This calculation element could, with the estimation component discussed briefly above, begin with a preset set of values, where the calculation component has various fields corresponding to the various expected cost points within a manufacturing process.

In addition to the steps identified above, additional steps are potentially useful to relay this information to potential project funders or to allow a more refined project creation process. For example, the system may score a project. In some embodiments, the score may be specified with a variety of badges, such as none, bronze, silver, or gold, depending on a calculation of the quality and completeness of the project application process. Similarly, the system could recommend trusted partners, vendors, subcontractors, consultants, etc. to complete any specified incomplete steps, recommend an external project auditor to provide confidence to project funders, or similar evaluation and recommendation steps.

Next, after the project creator provides background information and the system provides recommendations for partners and scores for quality of submission, in some embodiments there is an explicit call for funding requests that may either be drawn from the earlier calculations or may be overridden to include desired profit margins and overhead, for example. Funding requests can either be a simple target or can include multiple targets and tiers including stretch goals, specific rewards for above and beyond funding expectation targets. Similarly, project funder reward levels and “prizes” and/or compensation can be configured at this point. Finally, the completed project is submitted to the system for optional review and publishing to a funding community. Reward levels and stretch goals may be entered at various earlier points within the process, for example before the cost calculation step, without changing the intended scope of the inventive subject matter.

Various embodiments provide facilities for interaction by the project funders. For example, embodiments provide the ability to search or browse for projects of interest, identify the quality of the project (which may include product creator reputations and/or project completeness and quality scores, medals, and badges), and the ability to offer to fund a project at a given amount.

Additionally, some embodiments provide a component of the system which handles the collection of the various funding requests against a particular project, evaluates the completeness of project funding, properly charging or not charging the funder depending upon a project at any level, including short goals, meeting funding goals, and paying the project creator (including optionally charging for the use of the crowdsourcing project site). In addition, the disclosed system of some embodiments also provides relevant notifications and analytics to all involved parties, and similar functions necessary for completeness of a computer software application.

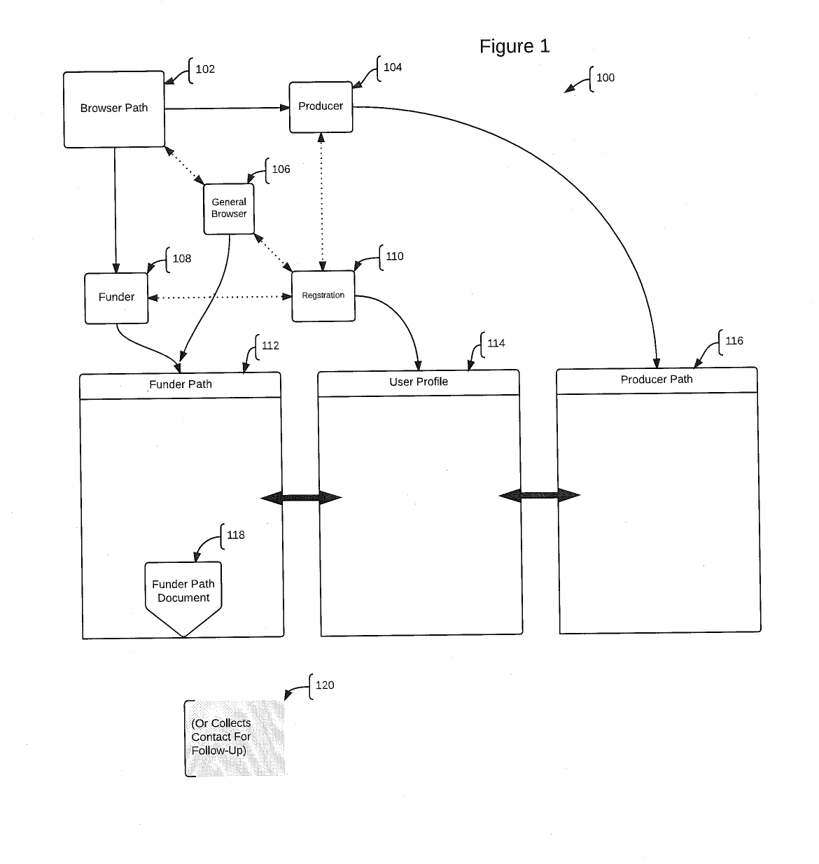

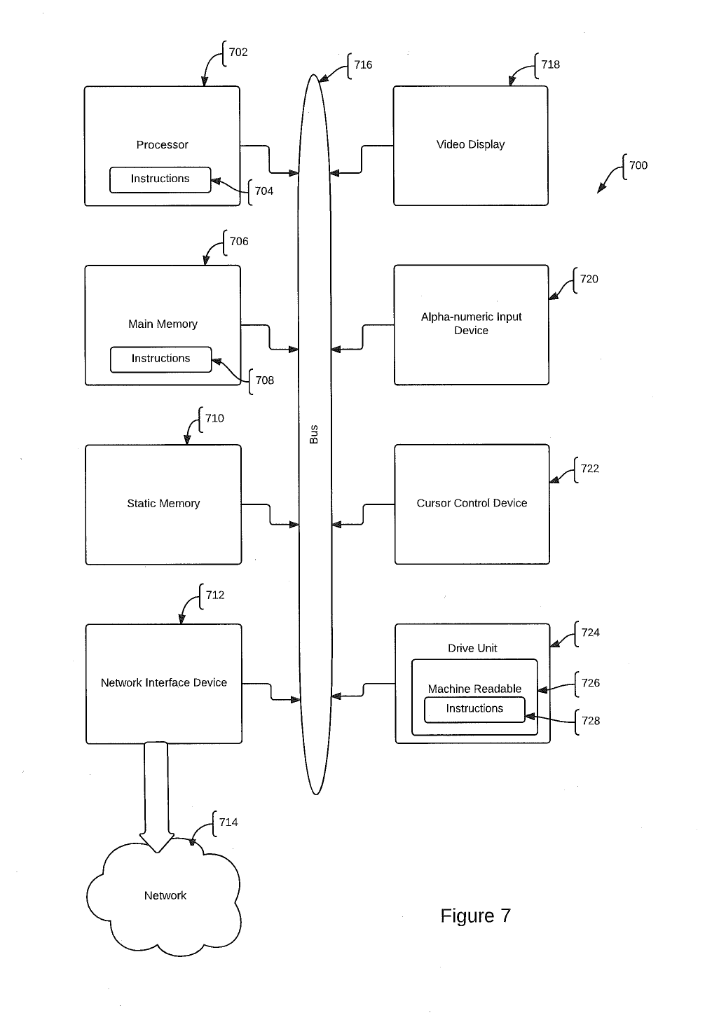

FIG. 1 is a block diagram of a system 100 according to embodiments. In some embodiments, system 100 includes an initial browser navigation path 102, a producer selection option 104 and a funder selection option 108. Alternate navigation paths include general browsing 106 and user registration 110. The embodiments as described herein involve use of some or all of the elements described in FIG. 7 such as processors, memories, storage devices, input/output devices and the like, even when not specifically referenced in other figures.

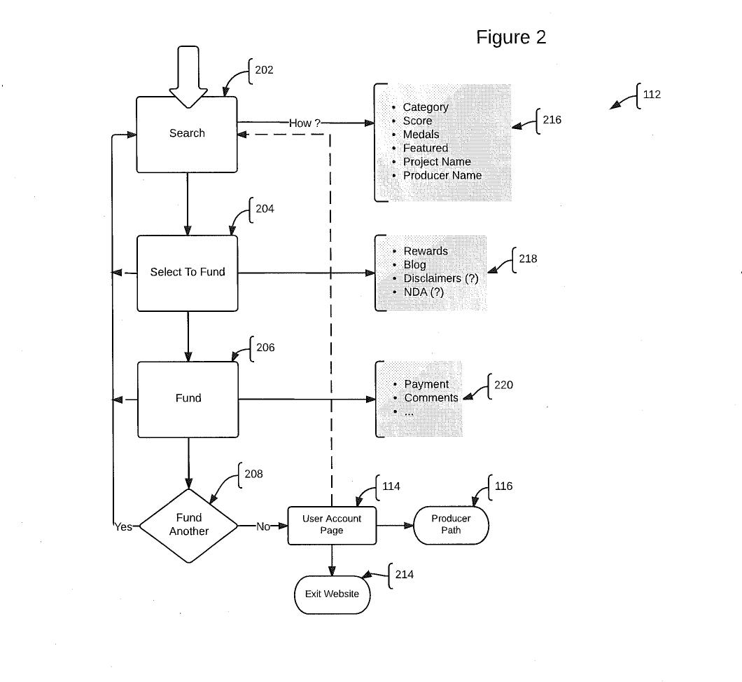

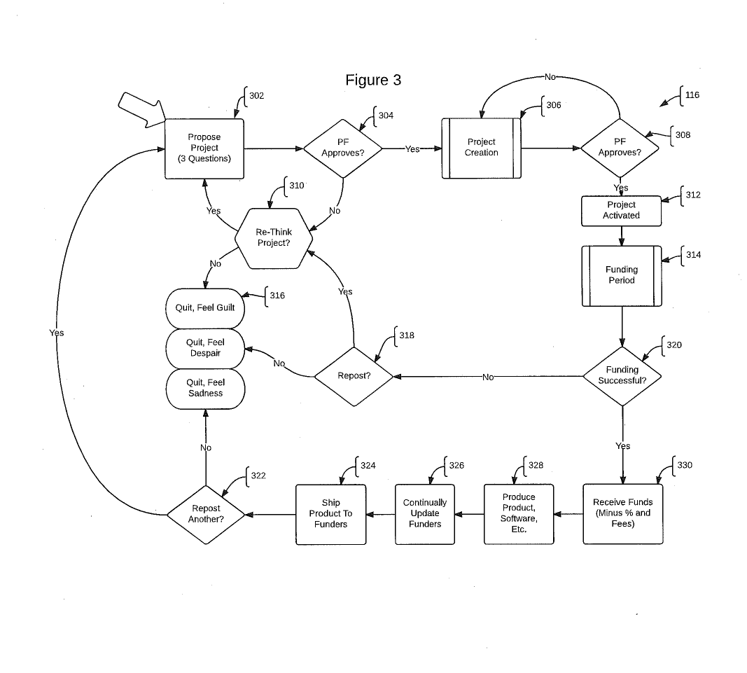

Upon selection of the funder option 108, work proceeds in the funder path 112 section which is described in more detail in FIG. 2. Upon selection of the producer option 104, work proceeds in the producer path 116 which is described in more detail in FIG. 3. Upon entering the registration option 110, work proceeds in the user profile creation section 114 which includes standard account profile creation known to one of ordinary skill in the art and not further described in figures. In each of the funder path 112, user profile 114, and producer path 116, various information can be provided in addition to that disclosed in subsequent figures, such as a funder path document 118 which is used to inform project funders about the crowdsourcing process, specific information about projects, system usage information, or other topics as appropriate. Similarly, alternate paths such as 120 can be used when appropriate.

As should be clear from FIG. 1, the user profile 114 in some embodiments is common whether one is a producer or funder and thus can be accessed from either channel path. This commonality provides for the recognition that in crowdsourcing social networks the role of individuals is somewhat fluid between producer and consumer. For instance, an individual may create a profile as a producer to begin the creation of a product, then later (perhaps even in the same work session) switch over to a funder and fund other projects in the system.

FIG. 2 is a block diagram of the funder path component 112 of the system 100 according to embodiments. In some embodiments, funder path component 112 contains steps to search 202, selection to fund 204, and fund 206 projects that are accessible to system 100. Options are provided to fund multiple projects 208, which in the positive condition will restart the search process 202. In the negative condition the funding user is optionally placed within their user account page 114 before they choose to move to a producer path 116 or exit the website 214. As shown via the connections within the diagram, the funder may opt to navigate away from any step in the process without leaving the system in an indeterminate state.

Each of the primary steps of search 202, select to fund 204, and fund 206 have numerous inputs and information transacted. For example, within the search 202 process there are many methods considered 216 which may provide search capabilities within the system, including but not limited to, selecting, searching, or filtering by category, score, medals (of producer or project), featured projects or producers, project name, audit level, or producer name

Similarly, within the select to fund step 204 there are many items for review or input 218 which may inform the decision to fund a project, including but not limited to, reviewing project descriptions, producer biographies and/or success rates, reviewing rewards for funding, reading project blogs or producer blogs, reviewing project marketing collateral, reviewing disclaimers and/or non-disclosure agreements (NDAs), and the like.

Finally, the funding step 206 also has associated information and data 220 including but not limited to negotiating a payment (whether immediate, delayed, in cash, credit, trade, or otherwise), providing comments on the project or about the producer, opening a dialog via any channels commonly used, such as instant message (IM) or chat, email (standard email, social network messaging, etc.), phone (cellular network, plain-old-telephone-system (POTS), etc.), voice (or video) over internet protocol (VOIP), etc., posting via social networks, and the like.

FIG. 3 is a block diagram of the project creator path component 116 of the system 100 according to embodiments. In some embodiments, project creator path component 116 contains steps to begin the project proposal 302, comprised in the example embodiment to include the three questions of “project name”, “any sales made so far”, and “project description” but could be any set of quickly answered questions to convey the project meaning. Processing then continues through an administrative or automated approval step 304 to determine whether the project is worthy of inclusion within the system. If the project is not approved, there follows a decision for whether or not there is opportunity to improve the submission 310. If the project can be reworked for inclusion, processing continues back at the beginning 302, or if the project is undesirable it is rejected 316.

Approval step 304 (and similarly step 308) is used to maintain project quality. Approval could simply be a manual process undertaken by an administrative user using external quality measures not encoded within the system. In this case the administrative user is provided an interaction point to read and review the project and route the project into an accepted or rejected queue. It is also envisioned that the review process could be automated as part of workflow. In this scenario, the administrator could create a set of acceptance or rejection rules based off of information available in the submission process resulting from step 302 (or similarly step 306). Standard workflow routing systems are well known in the art and could include in these instances, e.g. completeness of the submission, the amount of description in any portion of the submission, the specific words used in the submission, and the like. As described elsewhere in this disclosure, certain submission fields could be free-text and others could be structured selections. Each of the various fields and field types could be used independently in an automated workflow process to accept or reject projects.

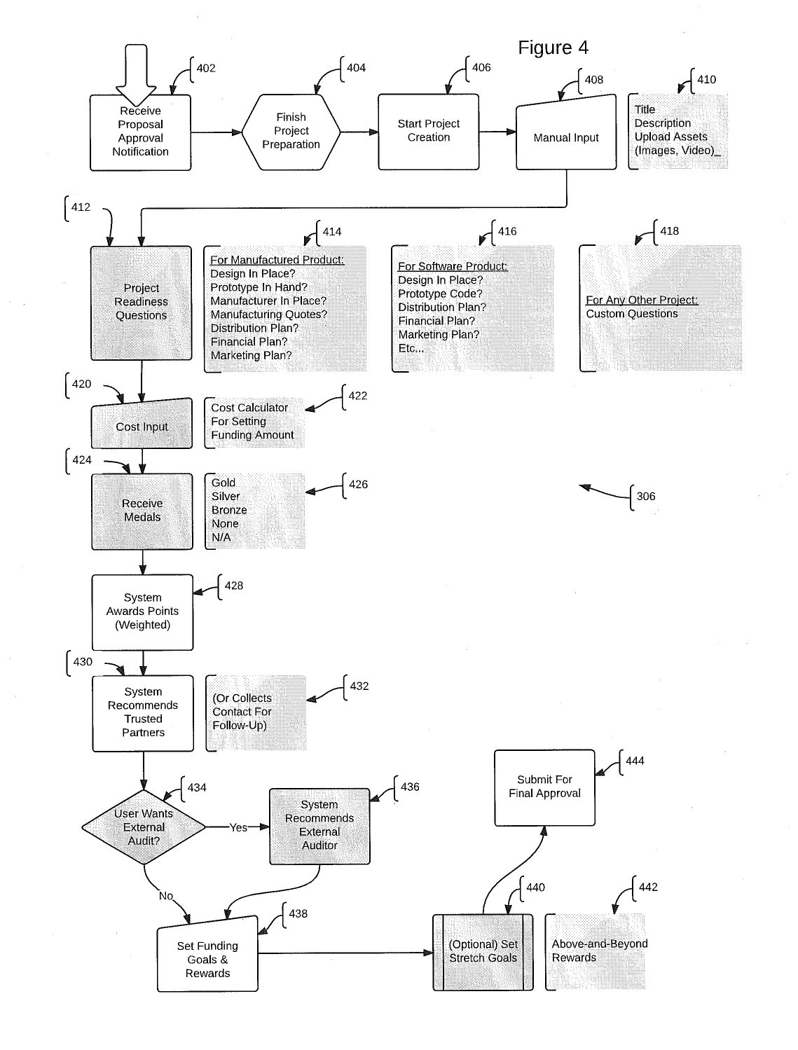

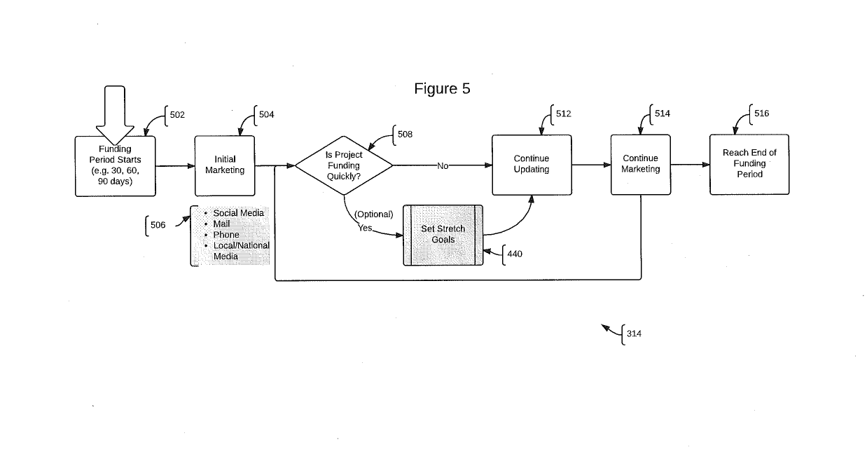

If the project is approved at step 304, processing continues with a project creation step 306 described in more detail in FIG. 4. After project creation, another administrative or automated approval step 308 occurs. If not approved, processing returns to the project creation 306 step, otherwise approval moves to a project activation 312 step. Activated projects then enter a funding period 314, which is explained in detail in FIG. 5. Upon completion of the funding period, funding is determined to either be successful or not 320. Unsuccessful projects allow the project creator to decide to repost 318 their project, at which point processing returns either to the opportunity to rethink/rework the project 310 or to exit and not try again 316.

If, however, the funding was successful, processing continues with a funds collection step 330. Collected funds may be transferred directly to the project creator, or may have a portion removed to cover commissions, usage fees, etc. At this point the project creator is notified to begin working on creating the product 328. Further, the system provides the opportunity to update the funders 326 about the ongoing status of the project and may also optionally remind the creator to provide the updates. Upon completion of the project by the creator, the creator ships the product to the funders and provides an opportunity to notify them of the completed product and shipment action 324. At this point, in some embodiments the project creator is provided the opportunity to create another project 322, at which point processing either returns to the beginning 302 or exits 316.

FIG. 4 is a block diagram providing further details of the project creation component 306 of the system according to embodiments. In some embodiments, project creation component 306 contains steps to receive the proposal approval notification 402 as an indicator to continue through the project creation process. This notification 402 provides the opportunity to the project creator to finish any outstanding tasks on project preparation 404 and begin with the project creation exercise 406. Project creation first includes manual input of unstructured information 408, such as (but not limited to) items shown in 410 of: project title, project description, and project assets such as images and video.

Following the unstructured data input, a series of structured data input occurs, the first being a set of project readiness questions 412. The set of questions may differ between various project types, for example for a manufactured product 414 the questions may include (but are not limited to): Design In Place?, Prototype In Hand?, Manufacturer In Place?, Manufacturing Quotes?, Distribution Plan?, Financial Plan?, Marketing Plan?, etc. Whereas, the questions for a software product 416 may include (but are not limited to): Design In Place?, Prototype Code?, Distribution Plan?, Financial Plan?, Marketing Plan?, Etc. Those of skill in the art having the benefit of the disclosure will appreciate that for other project types 418 the question sets may differ from manufactured or software products and that custom sets of questions may be provided for other project types. Further, some embodiments may provide for workflows for project types related to equity funding for a business or funding related to charitable causes. These project types may have question sets tailored to the specific requirements of such projects.

The next structured data sections include a cost input section 420, which may include questions in the form of a cost calculator 422 for setting funding amounts based on, for example, various responses to the project readiness questions 412 or other targeted cost questions.

Upon completion of these data input steps, the system awards quality metrics 424 to display in conjunction with a project, either overall or for each relevant detail. In one embodiment the quality metrics are presented as medals, such as gold, silver, bronze, none, or N/A 426. In alternative embodiments, other medal types or representations of quality may be provided, such as high/medium/low, red/yellow/green, happy/neutral/unhappy, numerical scores, and others as will be appreciated by one of ordinary skill in the art having the benefit of the disclosure.

At this point the system awards points 428 to provide a normalized metric of project quality based on either direct calculation from the various medals 424 or as a weighted calculation where certain metrics 412, 420 are biased more than others.

At this point processing optionally continues to recommend trusted partners 430, or collects information for follow-up of potential partners 432. While some embodiments provide this step upon completion of the data entry, alternative embodiments could have these recommendations performed in parallel to the data input process at steps 412, 420 or other similar points upon which the various sub-elements of project status is known.

In some embodiments the trusted partners are identified external to the disclosed system through a business process which may include manual evaluation and/or licensing or usage fees. In this scenario the administrator is able to enter into the system a set of partners and the various attributes for each partner, e.g. prototyping, manufacturing, accounting, business law, intellectual property, etc. In alternative embodiments the trusted partner entry could be automated or handled by the system and partners directly. It is envisioned that businesses could enter their own information into the system as potential partners. Then, with repeated use and positive feedback, these partners could be considered “trusted” and may receive preferential billing in recommendation steps 430, 432. Similarly, in another alternative embodiment, the system could identify partners within or outside the system based upon search criteria identified by the system as relevant to the current project and validate the quality of the candidate recommendation by using historical information within the system or use external rating sources to evaluate the quality of the business.

Processing now continues to an optional step of allowing for an external audit 434. Project creators may find increased funding acceptance if their project status is evaluated by a third party, so they may opt to choose to use an auditor, which would then be recommended to them 436 similar to how trusted partners are recommended 430.

In this scenario it is expected that there will only be a few auditors available and in the business of auditing projects. These auditors would be entered manually by an administrator and the project creator could then choose an auditor based on the information available as entered by the administrator. Alternative embodiments may include processes similar to those for determining trusted partners disclosed earlier, including automated or semi-automated approaches as previously disclosed.

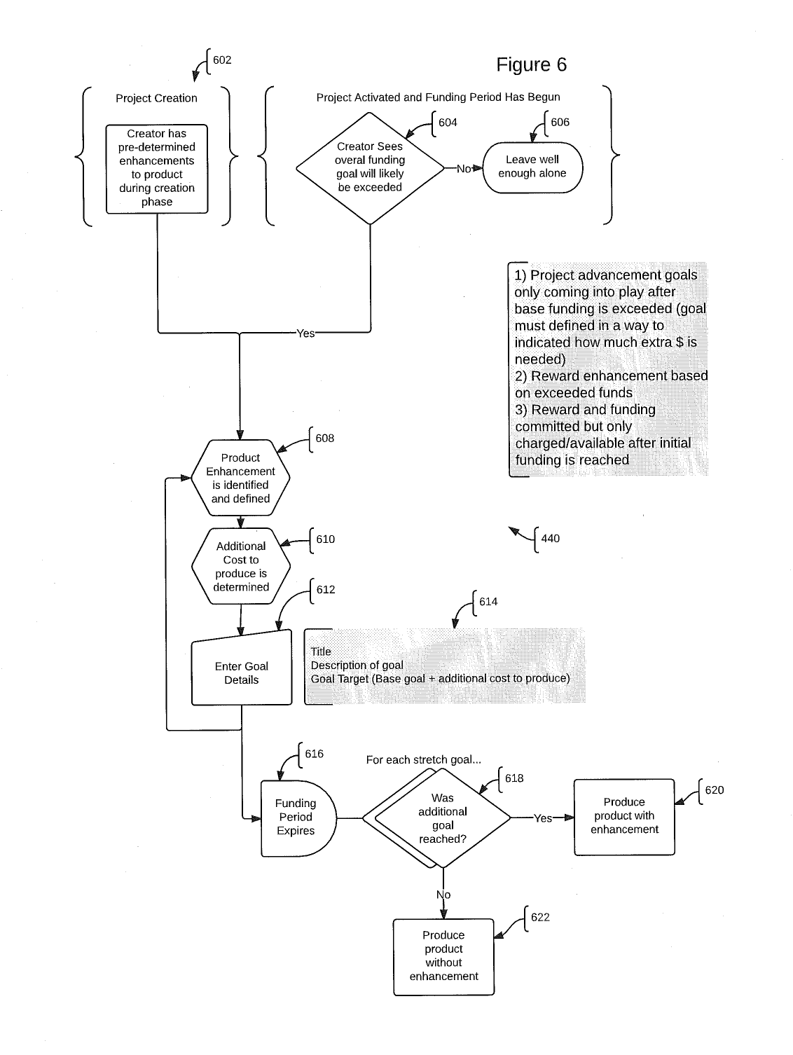

Finally, the project creator has the opportunity to set funding goals and rewards 438. Funding goals are based upon but not limited to the results of the cost input 420, allowing the creator to include overhead, unforeseen expenses, profit, and the like that are not necessarily otherwise part of the cost calculation steps. In addition, a common concept within crowdfunding for projects is to provide various rewards for different contribution levels. For example, a low bid may receive a marketing tchotchke, slightly more may receive a promotional t-shirt, more may receive the produced product, and top tier contributions may receive a limited edition or otherwise special product. Upon completion of this step the project creator has the optional ability to create and set stretch goals 440 containing above and beyond funding expectation rewards 442. Stretch goals are covered in more detail in FIG. 6. Finally the project is submitted for final approval 444 by administrators or automated processes.

FIG. 5 is a block diagram of the funding period component 314 of the system according to embodiments. In some embodiments, funding period component 314 contains steps to start a funding period 502 of various durations. Considered durations include 30, 60, and 90 days, but other ranges are possible as part of the disclosed inventive subject matter, including custom user chosen periods, fixed system periods, or other variations. Upon the start of the funding period, the system provides the ability to market 504 the project via a number of channels shown by example in item 506 to include social media, mail (email or postal), phone (cellular, POTS, VOIP, etc.), Local/National media, etc. Standard marketing channels and methods are well known in the art and the system disclosed herein provides the opportunity to interact with said known art.

A decision about the rate of engagement by a funding audience is then used to inform the project creator (either manual observation of metrics or automatically, via analytics, or similar other methods) whether the project is funding quickly 508 and thus could fund well above the original goal, or provide notice to entice backers if a project is not funding quickly, allowing the project creator the optional opportunity to set stretch goals 440 (discussed in more detail in FIG. 6). For example, if a project receives 90% of the target funding within one week of the start of a month-long funding period, it would behoove the project creator to take advantage of adding stretch goals 440 to produce a larger or more functional product offering. Throughout the funding period 314 the project creator has the opportunity to continue updating the project 512 with additional information, changes to the project, or other information relevant to the ongoing project. Similarly, the project creator has the opportunity throughout the funding period to continue marketing activities 514 until the end of the funding period is reached 516. Throughout the entire project creation and funding process, scores/medals/badges will be updated as better information becomes available. For example, it is envisioned that if badges for marketing activities are available, then a new project may not have a marketing badge applied, but after a marketing effort (of emails, social network campaigns, or other relevant marketing events) the system may then award a marketing badge and make that available to the project creator to view and optionally make that part of the publically visible project profile.

Clearly the specific order of the described steps may change without changing to concept of the funding period described in FIG. 5. For example, the specific order of updating 512 and marketing 514 is not specific to the shown sequence and placing step 514 before 512 and other similar sequence changes are within the scope of the inventive subject matter.

FIG. 6 is a block diagram of the stretch goals component 440 of the system according to embodiments. In some embodiments, stretch goals component 440 contains entrance steps via either of two conditions to achieve the same functionality. First, as seen in FIG. 4, during project creation 602 the creator envisions various product enhancements that could come from additional funding and encodes them within the system. Alternately, if the project is already activated and the funding period has begun as in FIG. 5, the stretch goal entry point happens when the creator identifies through monitoring status, analyzing analytics, or being notified by the system that the original funding goal will likely be exceeded, e.g. at blocks 604 or 508 (FIG. 5) and they should make a decision to do nothing 606 or to create additional funding goals.

To create a set of stretch goals, first the creator identifies and defines product enhancements 608 beyond the original product description. Then, for each enhancement the creator must determine the additional costs 610 to create that enhancement. This cost calculation could be simply determined arbitrarily, or the system may provide access to an infrastructure similar to that described in FIG. 4 steps 412, 420, and perhaps 424, 428, 430 and related items. For each goal, specific goal details can be entered 612 into the system, for example items listed in 614 including (but not limited to): title, description of goal, goal target funding level, and other activities related to those described for FIG. 4 item 438. As noted by the looping structure from step 612 to 608, one or more stretch goals are considered in various embodiments should stretch goals be used at all.

Finally, upon reaching the completion of a funding period 314 (FIG. 3), 616, additional processing can be considered in conjunction with step 320 (FIG. 3). Steps 618, and 620 describe said additional processing performed in some embodiments. First, upon detecting the end of a funding period 616 the system must determine for each stretch goal whether or not the additional goal was reached 618. For each successfully reached goal the creator is notified to produce the product with the specific stretch goal enhancement 620. Similarly, the creator is notified of the failed stretch goals so they can choose to produce the product without the enhancement 622. One of ordinary skill in the art can identify numerous methods for notification including analytics, observation of funding levels, explicit notification, and other approaches.

Desirably, embodiments of the present inventive subject matter consider the opportunity to create the stretch goals at any point within the project from project creation and including an active project during a funding period. However, in some embodiments, funding for stretch goals comes into play on a project in response to determining the initial funding amount is reached and exceeded. Each stretch goal is considered in a tiered fashion in some embodiments so that once funding is reached for the original product then funding to reach the first stretch goal commences. Upon complete funding of the first stretch goal, funding to reach the second stretch goal commences, and so on. Alternate embodiments may allow for stretch goals to be funded in parallel and still be within the scope of the inventive subject matter. Finally, the stretch goals and the original product funding only incur a payment commitment (extracted from the funder and/or paid to the creator) after each funding goal is reached, and similarly the various rewards offered are only available after the funding goal is reached for the specific reward.

FIG. 7 is a block diagram of an example embodiment of a computer system 700 upon which embodiment's inventive subject matter can execute. The description of FIG. 7 is intended to provide a brief, general description of suitable computer hardware and a suitable computing environment in conjunction with which the embodiments may be implemented. In some embodiments, the embodiments are described in the general context of computer-executable instructions, such as program modules, being executed by a computer. Generally, program modules include routines, programs, objects, components, data structures, etc., that perform particular tasks or implement particular abstract data types.

The system as disclosed herein can be spread across many physical hosts. Therefore, many systems and sub-systems of FIG. 7 can be involved in implementing the inventive subject matter disclosed herein.

Moreover, those skilled in the art will appreciate that the embodiments may be practiced with other computer system configurations, including hand-held devices, multiprocessor systems, microprocessor-based or programmable consumer electronics, network PCs, minicomputers, mainframe computers, and the like. The embodiments may also be practiced in distributed computer environments where tasks are performed by I/O remote processing devices that are linked through a communications network. In a distributed computing environment, program modules may be located in both local and remote memory storage devices.

In the embodiment shown in FIG. 7, a hardware and operating environment is provided that is applicable to both servers and/or remote clients.

With reference to FIG. 7, an example embodiment extends to a machine in the example form of a computer system 700 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU), a graphics processing unit (GPU) or both), a main memory 706 and a static memory 710, which communicate with each other via a bus 716. The computer system 700 may further include a video display unit 718 (e.g., a liquid crystal display (LCD) or a cathode ray tube (CRT)). In example embodiments, the computer system 700 also includes one or more of an alpha-numeric input device 720 (e.g., a keyboard), a user interface (UI) navigation device or cursor control device 722 (e.g., a mouse), a disk drive unit 724, a signal generation device (e.g., a speaker), and a network interface device 712.

The disk drive unit 724 includes a machine-readable medium 726 on which is stored one or more sets of instructions 728 and data structures (e.g., software instructions) embodying or used by any one or more of the methodologies or functions described herein. The instructions 728 may also reside, completely or at least partially, within the main memory 708 or within the processor 704 during execution thereof by the computer system 700, the main memory 706 and the processor 702 also constituting machine-readable media.

While the machine-readable medium 726 is shown in an example embodiment to be a single medium, the term “machine-readable medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information for a period of time, however brief Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 728 may further be transmitted or received over a communications network 714 using a transmission medium via the network interface device 712 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, wireless data networks (e.g., WiFi and WiMax networks), as well as any proprietary electronic communications systems that might be used. The term “transmission medium” shall be taken to include any intangible medium that is capable of storing, encoding, or carrying instructions for execution by the machine, and includes digital or analog communications signals or other intangible medium to facilitate communication of such software.

The example computer system 700, in the preferred embodiment, includes operation of the entire system on a remote server with interactions occurring from individual connections over the network 714 to handle user input for either the funder path 112 or the producer path 116 as an internet application.

As should be evident from the above description, several elements distinguish the inventive subject matter from prior art in significant and beneficial ways. Specifically, no prior art system provides a quality scoring metric (e.g. in the form of medals) to allow for formal evaluation of the quality of the project. No prior art system provides the capability for a third party audit of the project status evaluation which resulted in the quality scoring metrics, which offer a further validation of the project, and similarly identifying partnership opportunities during the project creation process. In addition, no prior art system allows project creators to dynamically add stretch goals at any point in the project creation and funding process as a structured step in a process, especially in consideration of the funding rate and likelihood of exceeding the original funding goal. Finally, no other prior art system provides a cost and project status calculation element to inform the project creator of the necessary steps involved in creating new products, estimating costs (including either a manual calculator/spreadsheet entry process or the consideration of average costs for each step in a process and automated prompting of necessary relevant or missing information), and otherwise providing a cost calculation framework to help accurately estimate the remaining cost and effort of a project, especially as an integrated method with project scoring metrics to help creators and funders evaluate potential flaws and missing steps in project conceptualization.

The following examples are provided to illustrate the operation of the above described systems and methods. Where applicable, references are made to figures as previously described. Figure element indicators are used to indicate specific figure elements where numerics 1xx refer to elements from FIG. 1, 2xx refer to elements from FIG. 2, and so on. While the various examples are presented as an interconnected narrative, the interconnection is not necessary or expected as an aspect of the inventive subject matter. The embodiments may only provide functionality for any single example, or even a related topic obvious to one of ordinary skill in the art, and still provide an experience unique in the art. In the examples below, references to “ProductFunder” refer to a system incorporating embodiments of the inventive subject matter.

### EXAMPLE 1

### Product

Joe is an innovator. He has recently come up with an idea for a dog Frisbee that is durable and resistant to chewing damage. He does some market research and determines that there is nothing similar on the market and proceeds to work with some manufacturing companies to get a prototype made so he can do some initial product and market testing. Unfortunately, this is the first time Joe has ever done this sort of thing and he is not entirely sure how to go through the full development exercise and reach an audience. A friend tells Joe about a web site, ProductFunder, which will help him get an audience for his new creation.

Joe visits ProductFunder and learns about the crowdfunding concept for new products. This is exactly what Joe needs, so he selects the producer option 104 and proceeds down the producer path 116. Here Joe is prompted with some very simple questions 302, such as “Project name”, “How much effort have you spent on this project to date?”, and “Have you made any sales yet?”. Joe quickly completes this questionnaire and submits his information. After a short delay he is notified that his project is approved 304 and he begins entering more detailed information about the project 306. He starts with the basics 408,410 of creating a more detailed title (“Dogbee durable dog Frisbee”), a detailed description including the work he has done, basic marketing material, and the like, and completes with uploading a dogbee brochure and a video of Joe explaining the benefits of the dogbee and demonstrating the prototypes with his dog.

At this point Joe is prompted with some specific project readiness questions 412, 414 in the form of quick yes/somewhat/no responses (Joe's responses indicated in the parentheticals): Design In Place? (yes) Prototype In Hand? (yes) Manufacturer In Place? (no) Manufacturing Quotes? (yes) Distribution Plan? (somewhat) Financial Plan? (no) Marketing Plan? (yes). During this process, Joe is reminded that he does need to finalize his manufacturer based on the quotes he received and once he does that he can make more progress on his distribution plan. But, Joe had not considered doing a financial plan and is thankful that ProductFunder prompted him to do this. He was also able to use the information from ProductFunder to learn what sorts of content needs to be in a financial plan which helped him since he has never made one before.

Joe now moves to the cost input step 420 which helps him estimate his project costs so he can set a realistic funding goal for the dogbee. The calculator is a series of questions for input that tally results similar to a spreadsheet. First, he is prompted in the design section: “You indicated that you have a design in place. Concept to full CAD renderings range from $50 to $500. How much have you spent on this design?” Since Joe did most of the work himself with the help from a friend, he enters $75. Next, the calculator asks, “What percentage complete is this design?” Joe has a full CAD design that he used for the prototype, so he enters 100%. The calculator now moves to the manufacturing section with, “You indicate you have a prototype already. Costs for a prototype typically range from a few dollars for something made from items around the house to over $1000. How much have you spent on your prototype(s)?” Joe had several professionally made dogbee prototypes, and enters what he paid the manufacturer, $350. Since manufacturing quotes are generally free, the calculator simply asks, “Did you spend anything on getting your manufacturing quotes?” and Joe enters “no”. The calculator next prompts Joe, “You indicate that you have not chosen a manufacturer yet. Manufacturing typically includes an initial setup cost as well as a cost per manufacturing lot. These costs range between $100 and $1500 for setup, and lot sizes vary in number and cost per unit. What do you estimate your setup costs?” Joe reviews his various quotes and enters the average setup cost of $250. The calculator now prompts, “What is your target cost for your first production lot?” Joe enters the average cost across his estimates again, $10,000. From here the calculator moves to the business costs section with the prompt, “You indicate that you have a partially completed distribution plan. Distribution plans typically involve working with sales partners, packaging, identifying shipping partners and other miscellaneous items, resulting in between 5 and 30 hours of effort. How much money have you spent on your distribution plan?” Joe enters his costs of $475. The calculator now prompts, “What percentage complete are you with your distribution plan?” Joe estimates he is about half way complete and enters 50%. The system then tallies $950 for the distribution plan and a running project total so far of $11,625. Next the calculator prompts, “You have not done a financial plan. Financial plans are important for a product development business and involve calculating the various costs you will incur including taxation and other items. Costs typically range between $300 and $3000. Please enter your estimated costs.” To which Joe takes a stab of $1000. Finally, Joe is prompted with, “You indicate you have completed a marketing plan. Marketing plans typically vary in cost from $500 to $2500. How much have you spent?” Joe enters $1250 and is shown a total project cost minimum estimate of $13,875.

Upon completing the cost input, Joe is now shown the medals 424 that he has been awarded based on his project input so far. He has a Gold for design, a Silver for manufacturing, and a Bronze for business, with an overall project medal of Silver. At this point the system recommends trusted partners 430 for Joe to work with on his incomplete items as well as other items that were not previously prompted. Thus, Joe sees recommendations for third party companies to do manufacturing, as well as accounting firms and general business consultancies for product distribution, but since he has completed other project steps he is not prompted with designer/graphic designer partners, prototyping companies, or similar partners. In addition, recommendations for Intellectual Property consultants are provided to cover trademark and patent protection issues even though no prompts were made for this type of content during project cost 420 or readiness questions 412. Joe is confident he has these pieces covered, so he skips this section. Had he selected one, he would have been taken to an area of more detailed explanation of an individual service, including potentially automated contact information.

Next, Joe is prompted with 434, “ProductFunder has discovered that projects using a third party auditor have more success with funding and more often exceed their initial funding goals. Would you like to use an auditor for your project?” Joe considers this, and agrees. He is given information on the various external auditor costs and services 436 and selects one for $150. He is notified that the auditor will contact him within 24 hours, and the $150 charge is added to his project cost estimate.

Joe now has the opportunity to enter funding goals and rewards 438. Here he is informed of his current minimum cost estimate of $14,025 and reminded that “ProductFunder takes a 5% commission on all successful projects and you are responsible for shipping your various products to the purchasers. In addition, a number of your earlier responses were estimates and you may wish to include additional overhead. What do you want to set as your initial funding level?” Joe considers this information and determines that he will ask for $20,000 for his first funding attempt. Next he enters his reward groups, “1 blue dogbee, $20”, “2 blue dogbees, $40”, “1 signed, special edition dogbee+dogbee bumper sticker, $50. Finally, Joe indicates that he would like his project funding request to run for 30 days. Joe is now prompted with the option of creating stretch goals 440 in case his initial funding level is exceeded. Joe had already considered this 602 and remembers that his manufacturing estimates included additional setup costs of $250 for each different color he might want to produce 608, 610. He then considers the lot sizes and mailing costs, and enters 612 a funding tier of $25,000 with the rewards, “1 red dogbee, $20”, “1 red and 1 blue dogbee, $40”, and “1 red and 1 blue signed, special edition dogbees+2 bumper stickers, $60”. Satisfied, Joe submits his completed project for approval 444. Again, Joe's project is quickly approved 308 and he is notified that his project is active (or given the option to activate it at his discretion) 312 and his funding period 314, 502 has started.

Joe now advertises to all his friends and contacts 504 that he has a project running on ProductFunder. Because he is curious how his project is progressing, he obsessively checks back on a daily basis to provide updates 512 and continue getting the word out 514. One day, part way through the funding cycle, Joe notices that the project has reached its full funding and is nearing funding of his stretch goal 508, 604! He chooses to enter several more stretch goals 440, 60, 610, 612, at $30,000, $35,000, and $50,000 for green, yellow, and glow in the dark versions with similar rewards as on the earlier stretch goal for red. Eventually the end of the funding period is reached 516, 616 and Joe is notified that the funding was successful 320 at $32,720 funding his original product, as well as the first and second stretch goals 618 and that Joe needs to produce a blue, red, and green dogbee 328, 620. At the same time, the system charges the credit cards of the various funders, takes the usage fee for ProductFunder, and credits Joe's account 330.

During the funding period 314, Sally decides she is interested in looking into some new crowdsourced product opportunities. She has used other sites in the past and been unhappy about the unreliability of the product completion rates for products she has funded. She decides to try using ProductFunder to see if they are better than her past experiences. Sally visits the ProductFunder web site 102 and begins to browse some top listed projects 106. She is then brought through to the funder path 112 where she has the opportunity to do a more detailed search 202 of projects. Sally, having had bad experiences on other sites in the past, chooses to filter the projects she is interested in by project medals of silver or higher and only the audited projects 216. Joe's dogbee project is one of the first to catch her eye, and she selects it 204 to get more information. Here Sally sees the detailed description of the dogbee project 218, watches Joe's video and is quite interested in the dogbee for her two dogs who destroy all their toys in a matter of days. She review's Joe's profile, which is scant but positive from other people interested in the dogbee. She reads the dogbee project blog and likes the attention to detail and the various demonstrations of commitment to the project that Joe relays—clearly he is serious and has thought through the various steps necessary to get the dogbees made successfully. Sally notices that the project has only been active for a short time but is nearing its original funding target. Sally decides to fund 206 the dogbee project by purchasing two dogbees. The ProductFunder site now prompts Sally to complete her profile and enter her credit card information 220 for billing, as well as provide various information and agreement documents 118. Sally is also able to quickly post comments about the dogbee project and Joe on the ProductFunder site, as well as share with her friends via twitter and Facebook, her preferred social networks, that she is using ProductFunder to get two dogbee dog Frisbees. Sally is very happy with her experience.

Now that the funding period 314 has ended, funds have been transferred 330, and notifications to all parties sent out 328, Joe is on the hook to actually make a bunch of dogbees! He finds the processes he worked through to create the project 306 have given him the pieces he needs to effectively produce the dogbee 328. With each new step along the production of the dogbee, Joe uses ProductFunder to update the funders 326 about where he is in the development cycle. These updates keep Joe focused on the task at hand and they keep his funders interested in the dogbee; they feel a personal connection to the creation of a new product. Eventually the dogbee's full production run is completed and Joe begins packaging and shipping to each of his funders 324 the dogbees and tchotchkes they have purchased. Joe updates the ProductFunder site to indicate that the dogbees have shipped and subsequently upon receipt of their dogbees, many purchasers come back and give the project and Joe raving reviews. Joe's reputation on ProductFunder is now much higher, earning him a gold medal as a successful product creator and rave reviews. Joe sees the ProductFunder site now shows he has had one successful funded project, funded at 164% for over $32,000. He received 523 positive comments and 0 negative comments. Joe also notices that he also received a silver medal for the total number of social network shares that his funders did about the project. Joe had a fun time, found the ProductFunder process immensely helpful, and was able to build a loyal customer base for what started as just a crazy idea, in addition to making some money in the process. He will probably use ProductFunder again.

### EXAMPLE 2

### Software

Joe's brother Bill saw how much ProductFunder helped Joe. Bill has had an idea for a software game that runs on an iPad®, but was not sure how to go about getting the money necessary to take his time off to program it. Bill decides to follow the same ProductFunder process for his software game that Joe did for his physical product. However, as Bill works through the ProductFunder site, he finds several key differences from what Joe experienced. For example, since software does not have the same steps to produce as physical products, the project creation steps 306 also were different. Specifically, Bill was prompted with a different set of project readiness questions 412 than Joe experienced. Namely, Bill was prompted not with questions like “Prototype in hand” or “Manufacturer in place” 414 but with variations “Prototype code written”, “User interface design complete?”, “Back-end design complete?”, “Storyboard complete?” and similar software related steps and terms. In addition, the cost inputs 420 were tailored to software project inputs, including questions about server infrastructure costs (e.g. Amazon EC2 cloud server costs, etc.) as well as recognizing the different cost structures for software distribution as compared to physical product distribution.

Thus, since the software funding project questions and cost calculator details are different, so are the medals awarded 424, 428. Bill is able to secure a gold medal, for example, relevant to his design for security around in-app purchases, but only scores a bronze for user interface because he is still working on the game graphics with a designer.

Similarly, the funding goals, rewards, and stretch goals are different between software and physical products. Where Joe was able to make small color changes for a small increment in his manufacturing costs, Bill has different increments based on his ability to add more features and levels to the game for everyone if the funding tiers are met. Since software does not have an incremental cost per item sold in the same way as physical products, Bill must determine his cost to produce each new feature and game level (as aided by the cost calculator 420 and project readiness questions 412) and set that as the tier level. Similarly, Bill must determine a logical ordering of tiers in a way that Joe did not need to consider. Where Joe simply chose color preferences as his tier ordering, Bill must consider that his extra game levels must be funded in a logical order so the easier levels come before the more challenging game levels. Notably, the larger funding amount to get the game infrastructure and basic game levels is his original funding goal, and each set of additional game levels are stretch goals.

As should be clear to one of ordinary skill in software development, numerous specific steps not specifically addressed in this example are considered as part of the unique steps the software project creator must follow, but for brevity are left out of this example.

### EXAMPLE 3

### Creative

Sally, besides owning destructive dogs, is also an artist. She makes mixed-media sculptural pieces. She thought about the positive experience she had buying a dogbee and checked into using ProductFunder for helping fund the making of her next sculpture installation. Sally's project is more distinct from Joe's dogbee project than Bill's software game was. Namely, Sally only produces a single sculpture but relies on multiple people to fund the artwork. Clearly each funder does not get the final product of Sally's work, resulting in the rewards being quite distinct. Similarly, artistic compositions are usually designed “whole cloth”, meaning that stretch goals are used for different purposes. And, the various project readiness questions and cost calculations as well as the resulting medals are also unique for this type of project.

As Sally begins the ProductFunder process for her sculptural work, she notices that her existing funding account 114 is already in place to use as a starting point for her new role as producer 104, 116, including her medals from her previous funding status, social network sharing, and feedback. As she reaches the detailed product creation steps, she is also happy to see that ProductFunder project readiness questions 412 are geared toward her specific artistic endeavor, prompting for “Preliminary design sketches completed?”, “Foundry in place (for metal casting projects only)?”, “Structural design complete (for large objects)?”, “Sculpture installation location selected?”, “Sculpture installation cost plan complete?” and other related questions to producing a sculptural installation 418. As expected, the cost input 420 reflects the various costs that arise related to the project readiness questions 418, and the medals 424 are similarly linked. Similarly, recommendations for trusted partners 430 includes partners specific to Sally's project, such as metal casting partners, welders, and the like.

When Sally gets to the funding goals and rewards 438, she sets her goal to get the sculpture completed, but her reward is simply an “I support the arts” bumper sticker. In addition, her stretch goals are for additional transport fees for displaying the sculpture in various exhibitions such as Sculpture by the Sea (see e.g., the URL “www.sculpturebythesea.com/”) before the final permanent installation.

Similar variations in project questions, funding reward tiers, etc., would be similar to the above example should Sally have been a musician or cinematographer instead of a sculptor.

### EXAMPLE 4

### Equity

Bill's software game was so successful he decided to turn his hobby into a company, DogTooth games. He was able to take his successes with the initial game and in-game purchases to allow him to quit his day job as an IT support person and spend full time on his gaming dream. He has also hired two others to help out, and received some initial success in the market. However, he has reached a point where he needs to have extra capital to grow the business, and he is willing to sell some equity in the company to gain that capital. This money will help him increase his staff and marketing and if all goes well, will move him into consideration as a major game studio. So, going back to his roots, Bill visits ProductFunder to raise capital through the sale of business equity.

The steps for preparing a business for an equity event are significant. Numerous business, financial, legal, and regulatory hurdles must be passed. As should be clear from previous examples, the primary points of distinction between different funding types exist primarily in the project readiness questions 412 to handle specific steps relevant to a given project type 418, as well as mirroring those steps in the cost calculator 420. For equity, the questions 418 would focus on the various business, regulatory, financial, and legal requirements. Among other relevant questions, queries into board approval, prior investors, financial audits, etc. are relevant to an equity event. Similarly, when creating the project Bill must select how to handle the funders, either as a group or as individuals, in terms of voting shares and corporate direction. Again medals are awarded 426, 428 for the quality and status of the project and partner recommendations 430 are relevant to accounting firms, legal firms, etc. as appropriate for an equity event.

Clearly reward levels 438 and stretch goals 440 for equity project types are distinct from physical product, software, artistic, or other project types. Commonly shares in the company are given for certain funding levels, say a $50,000 contribution receives 100,000 shares. However, different types of shares may be available, such as voting or non-voting shares, dividend or non-dividend providing shares, preferred shares, or other options such as product royalties are considered and allowed. Stretch goals can be used to handle oversubscription scenarios where the stock proved in higher demand than expected and thus additional shares may be sold at higher prices, say a $50,000 contribution during the stretch goal period would only receive 50,000 shares as compared to the 100,000 it would have received earlier.

### EXAMPLE 5

### Causes

Sally's sister Susie is the head of a local US 501c3 charity to take dogs hiking. Susie would like to do a fund raiser for the dog hiking program, and has a target project of acquiring a small plot of forest land to use as a dog park. As should be obvious, Susie turns to ProductFunder to help run the charity event. Again, the main variations in ProductFunder for charitable causes versus physical products, software, artistic endeavors, and equity events lie in the specific project readiness questions 412, 418. Charitable causes have a range of questions that are quite distinct from product creation questions, such as, “Do you have a project goal, or is this to fund existing operations?”, “If the goal is the acquisition of assets, has a price for the assets been negotiated?”, “Is the contract for asset acquisition complete?”, etc., and these questions are similarly reflected in the cost calculator 420 and medal process 424, 428.

Project rewards 438 for charitable projects are commonly simply receipts for tax purposes with no other tangible exchange, donated items or commemorative signage/naming opportunities. For example, a local restaurant may donate five $50 gift certificates that Sally can list as an initial reward goal for a $50 contribution. Of note, only five of these specific rewards are available and the system must track when they have all been taken so to not offer that reward again. Similarly, rewards can be the contributor's name on a brick on the park entryway, which may be an unlimited item available for a $50 donation, or may include a special recognition dinner for contributors of $1000 or more. In this case, stretch goals can be the inclusion of additional donated items (e.g. Joe's donation of 20 dogbees that Susie lists for $20 each) which don't coincide with reaching a specific funding tier before being offered, or they may include incentives to get even more or repeat contributions by increasing reward desirability upon reaching specific funding goals. For example, upon reaching the initial goal of $50,000 for property acquisition, Susie may have a stretch goal increment of another $5000 to include a dog splash pond supported by specific items focused on that goal, and another $50,000 stretch goal for purchasing the adjacent property, $10,000 for improving the parking area and fencing, etc.

The range of causes envisioned is large, including non-profit corporations as described, but also individual or corporate fund raisers such as raising money for medical bills for an individual or a corporation doing a food bank fund raiser. In these scenarios, pledges can apply to specific activities (e.g. the November 2012 food bank fundraiser), projects (e.g. the purchase of land for a dog park, improving the dog park), or fees (e.g. medical bills, phone systems for the suicide hotline).

The examples provided above are not intended to be an exhaustive explanation of each possible operation of the systems and methods described herein, and the various embodiments are not limited to any example described above.

Although an overview of the inventive subject matter has been described with reference to specific example embodiments, various modifications and changes may be made to these embodiments without departing from the broader spirit and scope of inventive subject matter. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A method in a workflow system, the method comprising:
receiving a project type for a project;
determining, at least in part based on the project type, a set of one or more steps of a workflow for the project;
determining one or more actions to complete the set of one or more steps of the workflow; and
determining, based at least in part on the one or more actions, a cost for the workflow.

2. The method of claim 1, further comprising scoring the project based at least in part on a completeness of the workflow.

3. The method of claim 2, wherein scoring the project includes assigning one or more of a point value, a medal, or a badge based on the scoring of the project.

4. The method of claim 1, further comprising providing a recommendation for a goods or services provider for completing one or more steps in the workflow.

5. The method of claim 1, further comprising determining a level of knowledge of a user with respect to the set of one or more actions to complete one or more steps of the workflow.

6. The method of claim 1, further comprising:
receiving an indication that an audit of the project is desired; and
in response to receiving the indication that the audit of the project is desired:
providing a list of one or more auditors for selection,
receiving a selection of an auditor from the list, and
submitting an audit request to the selected auditor.

7. The method of claim 1, further comprising:
receiving a specification of one or more stretch goals associated with the project; and
determining a cost associated with each of the one or more stretch goals.

8. The method of claim 7, wherein the specification of the one or more stretch goals is received in response to determining that a funding rate for the project has exceeded a predetermined or configurable rate.

9. The method of claim 7, further comprising:
determining that funding for the project has exceeded an original funding level; in response to determining that funding for the project has exceeded the original funding level, determining if sufficient funding exists for at least one of the one or more stretch goals.

10. A machine-readable storage medium having machine executable instructions for causing one or more processors to perform operations comprising:
receiving a project type for a project;
determining, at least in part based on the project type, a set of one or more steps of a workflow for the project;
determining one or more actions to complete the set of one or more steps of the workflow; and
determining, based at least in part on the one or more actions, a cost for the workflow.

11. The machine-readable storage medium of claim 10, wherein the operations further comprise scoring the project based at least in part on a completeness of the workflow.

12. The machine-readable storage medium of claim 11, wherein scoring the project includes assigning one or more of a point value, a medal, or a badge based on the scoring of the project.

13. The machine-readable storage medium of claim 10, wherein the operations further comprise providing a recommendation for a goods or services provider for completing one or more steps in the workflow.

14. The machine-readable storage medium of claim 10, wherein the operations further comprise determining a level of knowledge of a user with respect to the set of one or more actions to complete one or more steps of the workflow.

15. The machine-readable storage medium of claim 10, wherein the operations further comprise:
receiving an indication that an audit of the project is desired; and
in response to receiving the indication that the audit of the project is desired:
providing a list of one or more auditors for selection,
receiving a selection of an auditor from the list, and
submitting an audit request to the selected auditor.

16. The machine-readable storage medium of claim 10, wherein the operations further comprise:
receiving a specification of one or more stretch goals associated with the project; and
determining a cost associated with each of the one or more stretch goals.

17. The machine-readable storage medium of claim 16, wherein the specification of the one or more stretch goals is received in response to determining that a funding rate for the project has exceeded a predetermined or configurable rate.

18. The machine-readable storage medium of claim 16, wherein the operations further comprise:
determining that funding for the project has exceeded an original funding level;
in response to determining that funding for the project has exceeded the original funding level, determining if sufficient funding exists for at least one of the one or more stretch goals.

19. A system comprising:
one or more processors; and
at least one machine readable storage medium communicably coupled to the one or more processors, the machine readable storage medium having machine executable code to cause the one or more processors to:
receive a project type for a project;
determine, at least in part based on the project type, a set of one or more steps of a workflow for the project;
determine one or more actions to complete the set of one or more steps of the workflow; and
determine, based at least in part on the one or more actions, a cost for the workflow.

20. The system of claim 19, wherein the machine executable code further includes machine executable code to cause the one or more processors to score the project based at least in part on a completeness of the workflow.

21. The system of claim 19, wherein the machine executable code to cause the one or more processors to score the project includes machine executable code to cause the one or more processors to assign one or more of a point value, a medal, or a badge based on the score of the project.

22. The system of claim 19, wherein the machine executable code further includes machine executable code to cause the one or more processors to provide a recommendation for a goods or services provider for completing one or more steps in the workflow.

23. The system of claim 19, wherein the machine executable code further includes machine executable code to cause the one or more processors to determine a level of knowledge of a user with respect to the set of one or more actions to complete one or more steps of the workflow.

24. The system of claim 19, wherein the machine executable code further includes machine executable code to cause the one or more processors to:
receive an indication that an audit of the project is desired; and
in response to receipt of the indication that the audit of the project is desired:
provide a list of one or more auditors for selection,
receive a selection of an auditor from the list, and
submit an audit request to the selected auditor.

25. The system of claim 19, wherein the machine executable code further includes machine executable code to cause the one or more processors to:
receive a specification of one or more stretch goals associated with the project; and
determine a cost associated with each of the one or more stretch goals.

26. The system of claim 25, wherein the specification of the one or more stretch goals is received in response to a determination that a funding rate for the project has exceeded a predetermined or configurable rate.

27. The system of claim 25, wherein the machine executable code further includes machine executable code to cause the one or more processors to:
determine that funding for the project has exceeded an original funding level;
in response to the determination that funding for the project has exceeded the original funding level, determine if sufficient funding exists for at least one of the one or more stretch goals.
